(19) United States
(12) Patent Application Publication
(10) Pub. No.: US 2007/0178431 A1
(43) Pub. Date: Aug. 2, 2007

(54) Training and testing flash cards

(76) Inventor: Jerry L. Sheeley, Virginia Beach, VA (US)

Correspondence Address: JAMES RAY & ASSOCIATES, 2640 PITCAIRN ROAD, MONROEVILLE, PA, 15146, US

(21) Appl. No.: 11/651,371

(22) Filed: Jan. 9, 2007

Related U.S. Application Data
(60) Provisional application No. 60/757,430, filed on Jan. 9, 2006.

(51) Int. Cl. G09B 3/00

(52) U.S. Cl. 434/322; 434/347

(57) ABSTRACT

A skill assessment tool made up of a set of cards, each of the cards being of a predetermined width and a predetermined height, and further preprinted with either questions or scenarios, and such cards each being provided with a substantially blank reverse side for writing an answer. One set of cards may be written to be used for interviewing job candidates, while other sets may be prepared specifically for testing newly-trained employees.

### CROSS REFERENCE TO RELATED APPLICATION

This patent application is related to and claims priority from U.S. Provisional Patent Application Ser. No. 60/757,430 filed Jan. 9, 2006.

### FIELD OF THE INVENTION

The present invention relates, in general, to employer assessment of abilities of prospective and current employees and, more particularly, this invention relates to flash cards that present mostly difficult scenarios or questions to ascertain an individual's ability to deal with them.

### BACKGROUND OF THE INVENTION

Prior to the conception and development of the present invention, there is a continuing need for employers to ensure that new employees get a minimum amount of training, and training beyond the minimum is advantageous as well. Confirmation of an employee's training may have come in the form of a signature on an attendance sheet, or an answer sheet for simple, multiple-choice questions. However, inexpensive training or testing for dealing with tough situations has been lacking, especially that tailored to a specific job situation or profession.

The use of flash cards is very prevalent in the education field, typically for rote memorization learning in mathematics or foreign languages. U.S. Pat. No. 6,439,572 teaches the use of flash cards in training young athletes.

There are numerous prior-art examples, such as U.S. Pat. No. 6,524,109, that teach computer-based training and skill assessment systems. While computers themselves may be inexpensive, specialized software and technical support may be cost prohibitive for many small or medium-size companies. In addition, it is also not customary or practical to interview a job candidate in front of a computer monitor.

### SUMMARY OF THE INVENTION

The present invention provides a skill assessment tool for allowing an employer to determine the capability of a potential of a new employee, utilizing a set of flash cards, each preprinted with either questions or scenarios.

### OBJECTS OF THE INVENTION

It is, therefore, one of the primary objects of the present invention to provide a skill assessment tool utilizing flash cards presenting either questions or scenarios for testing the capability of new employees.

Another object of the present invention is to provide an assessment tool for interviewing candidates for a certain position.

Another object of the present invention is to provide an assessment tool for interviewing candidates which is cost effective for a certain position.

In addition to the various objects and advantages of the present invention described with some degree of specificity above it should be noted that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 depicts a set of the flash cards.

FIG. 2 is a close up view of the question side of a flash card.

FIG. 3 is a close-up view of the answer side of a flash card.

### DESCRIPTION OF A PRESENTLY PREFERRED AND AN ALTERNATIVE EMBODIMENT OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

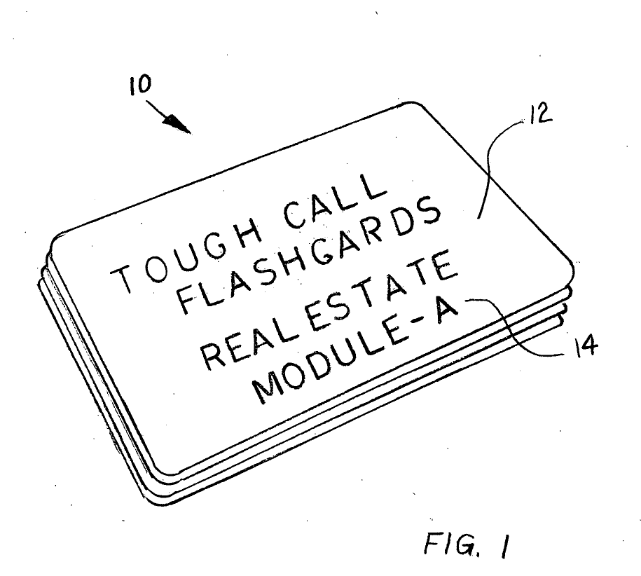

Referring initially to FIG. 1, depicted is a set of flash cards 10, which are typically assembled according to the profession 12, and then by topic 14.

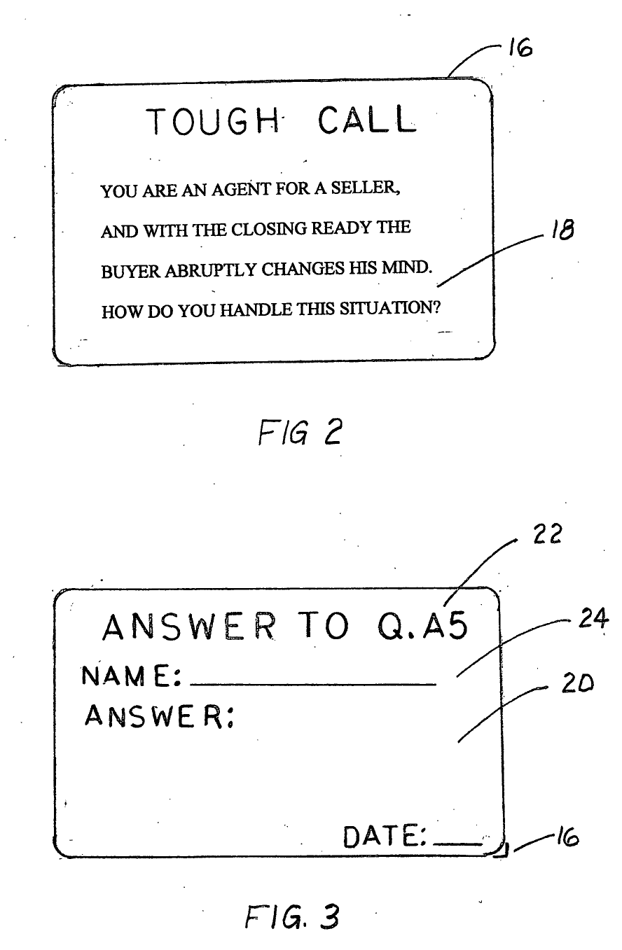

Referring to FIG. 2, an example flash card 16 is shown with a question 18 that may be pertinent to a real estate salesperson.

In FIG. 3, the answer side 20 of a typical card 16 is shown. It would generally have a pre-printed question number 22, a line for the name of the person answering 24, and may be removable, held in place by a pressure sensitive adhesive, or other means.

In one alternative embodiment, a blank space for an answer is left on the front side of the flash card, and the answer is entered by either the one asking the question or the person being questioned. For both embodiments, there is an accompanying computer program or files created in standard business software for easy and simple updating of the cards as business or legal conditions change.

While a presently preferred and one alternative embodiment of the present invention have been described in sufficient detail above to enable a person skilled in the relevant art to make and use the same, it should be obvious that various other adaptations and modifications can be envisioned by those persons skilled in such art without departing from either the spirit of the invention or the scope of the appended claims.

I claim:

1. A skill assessment tool, comprising a set of cards, each of said cards being of a predetermined width and a predetermined height, said each of said cards preprinted on one side thereof with one of questions and scenarios and said of each of said cards having a substantially blank reverse side for writing an answer.

2. The skill assessment tool, according to claim 1, wherein said scenarios present situations to a prospective employee that will ascertain basic problem-solving skills pertinent to a particular job.

3. The skill assessment tool, according to claim 1, wherein said questions ascertain acquired knowledge of a newly-trained employee.

4. The skill assessment tool, according to claim 1, wherein said predetermined height of said cards is between about four inches and eight inches.

5. The skill assessment tool, according to claim 1, wherein said predetermined width of said cards is between about six inches and ten inches.

6. The skill assessment tool, according to claim 1, wherein said reverse side is a removable sheet of paper.

7. The skill assessment tool, according to claim 1, wherein each of said cards of said set of cards is related to a predetermined topic.

8. A skill assessment tool, comprising a set of cards, each of said cards being of a predetermined width and a predetermined height, said each of said cards preprinted with a question, and includes a substantially blank area below said question for entering an answer.
